(19) United States
(12) Patent Application Publication
(10) Pub. No.: US 2024/0078485 A1
(43) Pub. Date: Mar. 7, 2024

(54) DATA MANAGEMENT SYSTEM AND DATA MANAGEMENT METHOD

(71) Applicant: Hitachi, Ltd., Tokyo (JP)

(72) Inventors: Makoto YAMAMOTO, Tokyo (JP); Ryo FURUHASHI, Tokyo (JP); Hiroshi MATOBA, Tokyo (JP)

(21) Appl. No.: 17/939,231

(22) Filed: Sep. 7, 2022

(30) Foreign Application Priority Data
May 20, 2022 (JP) 2022-082994

(51) Int. Cl. G06Q 10/06; G06Q 10/10

(52) U.S. Cl. CPC G06Q 10/06315; G06Q 10/10

(57) ABSTRACT

A data management system that enables appropriate management of data in offices is provided. A data management system including one or more server devices provided in each of a plurality of offices, in which: when receiving a request for data of another office from a client terminal, a setting unit sets information indicating acquisition of data of the other office in setting information; and an acquisition unit acquires the data of the other office from the server device in the other office according to the setting information in which a change is detected by a monitoring unit.

### CROSS-REFERENCE TO RELATED APPLICATION

This application claims priority pursuant to 35 U.S.C. § 119 from Japanese Patent Application No. 2022-082994, filed on May 20, 2022, the entire disclosure of which is hereby incorporated herein by reference.

### BACKGROUND

### Technical Field

The present invention generally relates to a technology for managing data in offices.

### Related Art

Conventionally, when linking data among offices, all pieces of data stored in server devices (edge) in the offices are aggregated in a cloud system (core), and then the pieces of data are linked via the cloud system (see Patent Literature 1).

In Japanese Patent Publication No. 5608811 (Patent Literature 1), there is disclosed the above conventional technology.

### SUMMARY OF THE INVENTION

The user analyzes the aggregated data using tools on the cloud system, for example, but along with recent tightening of rules for handling classified information such as personal information, there is also a need for analyzing data in the user's own office.

However, there is a problem that users in some offices accidentally transfer classified information to the cloud system.

The present invention has been made in view of the foregoing, and aims to present a data management system and the like that enable appropriate management of data in offices.

To solve the above problem, the present invention provides a data management system including one or more server devices provided in each of a plurality of offices, in which: the server device includes a setting unit that sets setting information including information indicating acquisition of metadata in which real data is excluded from data of another office from a server device in the other office, a monitoring unit that monitors setting information set by the setting unit, an acquisition unit that acquires metadata of the data of the other office from the server device in the other office according to setting information in which a change is detected by the monitoring unit, and a management unit that creates stub data which is data not including real data of the data of the other office and is data for referring to the data of the other office from metadata acquired by the acquisition unit and manages the stub data. When receiving a request for the data of the other office from a client terminal, the setting unit sets information indicating acquisition of the data of the other office in setting information, and the acquisition unit acquires the data of the other office from the server device in the other office according to the setting information in which a change is detected by the monitoring unit.

In the above configuration, a server device in one office directly acquires data of another office used for data analysis, for example, by bypassing the cloud system (core). According to the above configuration, when data of the other office is requested by the one office, for example, the server device in the one office acquires the data directly. Hence, the user in the other office is not required to upload the data to the cloud system, and a situation of accidentally transferring classified information to the cloud system can be avoided.

According to the present invention, it is possible to implement a highly convenient data management system. Problems, configuration, and effects other than the above are clarified in the following description of the embodiment.

### BRIEF DESCRIPTION OF THE DRAWINGS

FIG. 1 is a diagram showing an example of a configuration according to a data management system of a first embodiment;

FIG. 2 is a diagram showing an example of a configuration according to the data management system of the first embodiment;

FIG. 3 is a diagram showing an example of a data structure of a stub file of the first embodiment;

FIG. 4 is a diagram showing an example of a link setting file of the first embodiment;

FIG. 5 is a diagram showing an example of a link management file of the first embodiment;

FIG. 6 is a diagram showing an example of an office management file of the first embodiment;

FIG. 7 is a diagram showing an example of a processing flow of data link processing of the first embodiment;

FIG. 8 is a diagram showing an example of a sequence according to the data link processing of the first embodiment;

FIG. 9 is a diagram showing an example of a sequence according to the data link processing of the first embodiment;

FIG. 10 is a diagram showing an example of a processing flow of recall processing of the first embodiment;

FIG. 11 is a diagram showing an example of a sequence according to the recall processing of the first embodiment;

FIG. 12 is a diagram showing an example of a processing flow of error processing of the first embodiment;

FIG. 13 is a diagram showing an example of a sequence according to the error processing of the first embodiment;

and

FIG. 14 is a diagram showing an example of a sequence according to the error processing of the first embodiment.

### DETAILED DESCRIPTION OF THE EMBODIMENTS

### (I) First Embodiment

Hereinafter, an embodiment of the present invention will be described in detail. Note, however, that the present invention is not limited to the embodiment.

If server devices (edge) in different offices transfer a huge amount of data used for data analysis via a cloud system (core) in an aggregating office as in the conventional technology, the amount of charge for the cloud system increases, which increases cost. Additionally, the link via the cloud system increases the frequency of communication, which increases the amount of charge for the cloud system. Moreover, in a case where data of another office is managed as stub data, when the data is to be restored via the cloud system, there may be a shortage of the amount of resources (e.g., storage area capacity) necessary for storing the data of the other office.

Note that an office is an office including a local computer system, such as a branch office, a sales office, or a remote office where the user actually performs business operations. An aggregating office is an office including a remote computer system, such as an office that collectively manages server devices and storage devices, an office that provides a cloud service, and so forth.

In this regard, a data management system of the present embodiment achieves linkage of data among offices while bypassing the cloud system. More specifically, the user sets information of an office that he/she desires to be linked with as setting information. The data management system periodically monitors the setting information and links data according to the setting information. More specifically, the data management system periodically acquires, from the office set as the link target, resource information indicating the link target data and the amount of resources (e.g., storage area capacity) necessary for managing the data. Note that the user may be allowed to customize synchronization of data by setting the interval of data acquisition and the like.

Here, while conventional data linkage has been focusing only on linkage of data created by the user, the data management system enables propagation of resource information together with data created by the user. Since resource information is propagated in advance, no storage area shortage occurs during data acquisition among offices, so that acquired data of other offices can be held in the own office for the moment.

Additionally, assume a case where a link destination acquires resource information when the actual state of the resource is different from the appropriate state thereof due to a failure occurring at a link source. Even in this case, by acquiring new and correct resource information from the link source at the time of data linkage after recovery from the failure, the link destination can automatically acquire resource information without being aware of the failure at the link source.

Additionally, instead of forcibly establishing a link with all of the offices, the data management system can establish a link with only the link target indicated in the setting information. That is, instead of forcibly linking data among all of the offices like broadcasting, both parties are allowed to perform control as to whether or not to establish the link (whether or not to include link information in setting information). Moreover, even if a wrong link target is set in the setting information, unintended linkage can be prevented by performing authentication at the time of linkage using information such as an access key (ID), a secret access key (password), and so forth shared in advance.

Next, the embodiment of the present invention will be described with reference to the drawings. The following description and drawings are examples for describing the present invention, and are partially omitted and simplified as needed to facilitate understanding of the description. The present invention can be carried out in other various forms. It does not matter whether one or a plurality of each component is provided unless specifically stated otherwise.

Note that in the following description, the same elements are denoted by the same number in the drawings, and descriptions thereof are omitted as needed. When describing elements of the same type with no distinction between the elements, a common part (part excluding sub-number) of reference numerals including sub-numbers may be used, and when describing elements of the same type by making a distinction between the elements, reference numerals including sub-numbers may be used. For example, when describing a server device without particular distinction, it may be described as “server device 101,” and when describing individual server devices by making a distinction between the server devices, they may be described as “server device 101-1” and “server device 101-2.”

In the present specification and the like, wordings such as “first,” “second,” and “third” are added only to identify components, and do not necessarily limit the number or order of the components. Additionally, the numbers for identifying components are used for each particular context, and a number used in a particular context does not necessarily indicate the same configuration in another context. Additionally, in some cases, a component identified by a certain number may also have the function of a component identified by another number.

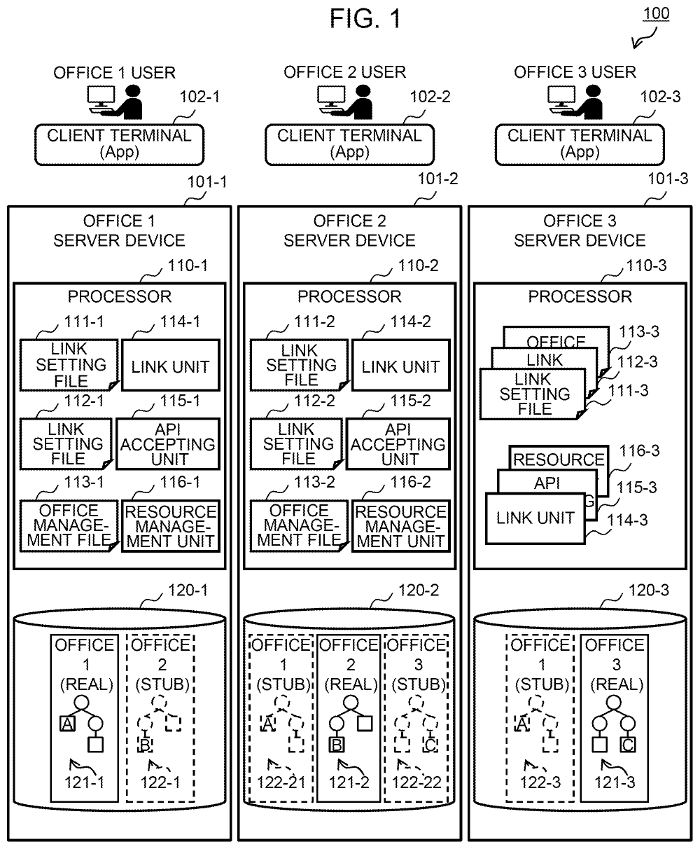

In FIG. 1, reference numeral 100 indicates a data management system of a first embodiment as a whole.

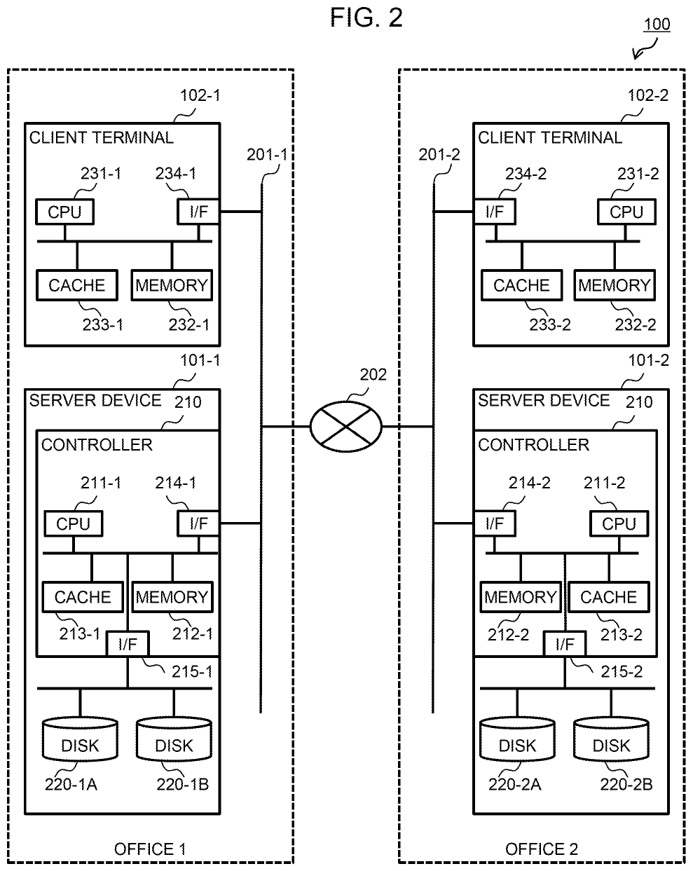

FIGS. 1 and 2 are diagrams showing an example of a configuration according to the data management system 100.

The data management system 100 is configured by including one or more server devices 101 for each office. The server device 101 is communicably coupled with a client terminal 102. A user in an office operates the client terminal 102 in an office in which he/she is present (hereinafter referred to as own office) to refer to data stored in the server device 101 in the own office or refer to data stored in the server device 101 in an office (hereinafter referred to as other office) different from the own office. In the data management system 100, a unit of data management may be a file, a block, or an object, and in the following description, a file is used as an example.

The server device 101 includes a processor 110 and a storage unit 120. The processor 110 is a computer, a circuit, an operating system (OS), an application program, and so forth, and links data related to files (hereinafter referred to as data link) with the processor 110 in the other office designated in advance, for example. The storage unit 120 is a file system, a node, and so forth, and stores a file of the own office as a real file 121 and stores a file of the other office as a stub file 122. Note that the processor 110 and the storage unit 120 may be communicably coupled via a network.

The stub file 122 is a file made of metadata, and does not include a real body (real data) of the real file 121. More specifically, the stub file 122 is a file that holds information (e.g., full path) for referring to the real file 121 in the server device 101 in the other office.

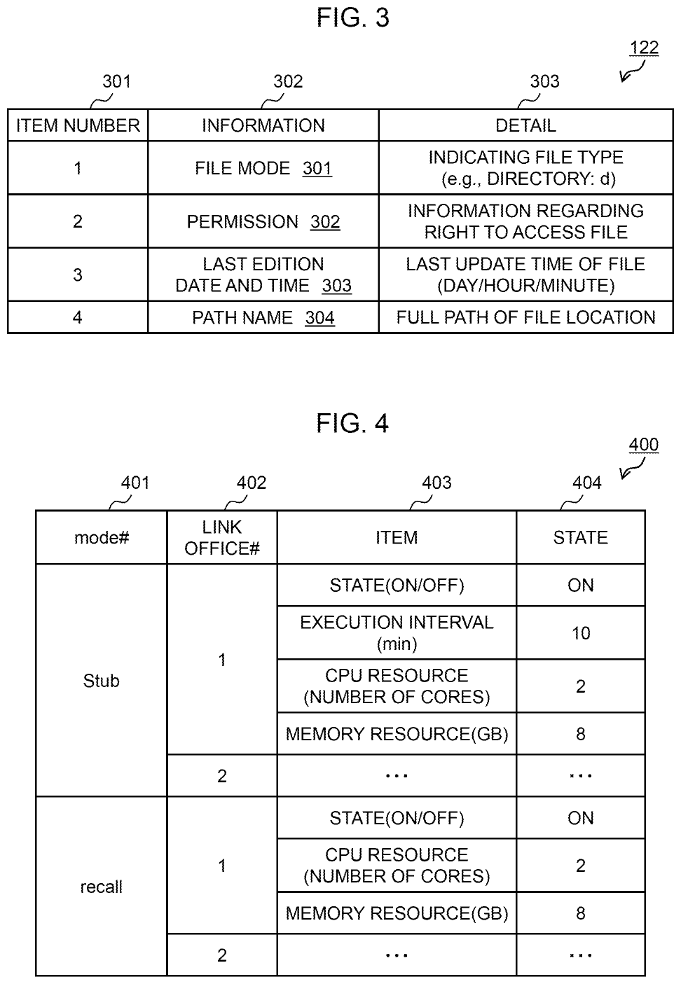

For example, when a server device 101-1 in a first office (office 1) performs data link with a server device 101-2 in a second office (office 2), the server device 101-1 in the first office basically stores a real file 121-2 in the second office converted into a stub file 122-1 in a storage unit 120-1 in the first office. As described above, since the real file 121-2 is in the second office and the stub file 122-1 of the real file 121-2 is in the first office, the server device 101-1 can grasp the file names of data in the second office from the stub file 122-1 without requiring much disk capacity. Note that the stub file 122 will be described later with reference to FIG. 3.

Additionally, the processor 110 manages a link setting file 111, a link management file 112, and an office management file 113. The processor 110 includes a link unit 114, an API accepting unit 115, and a resource management unit 116.

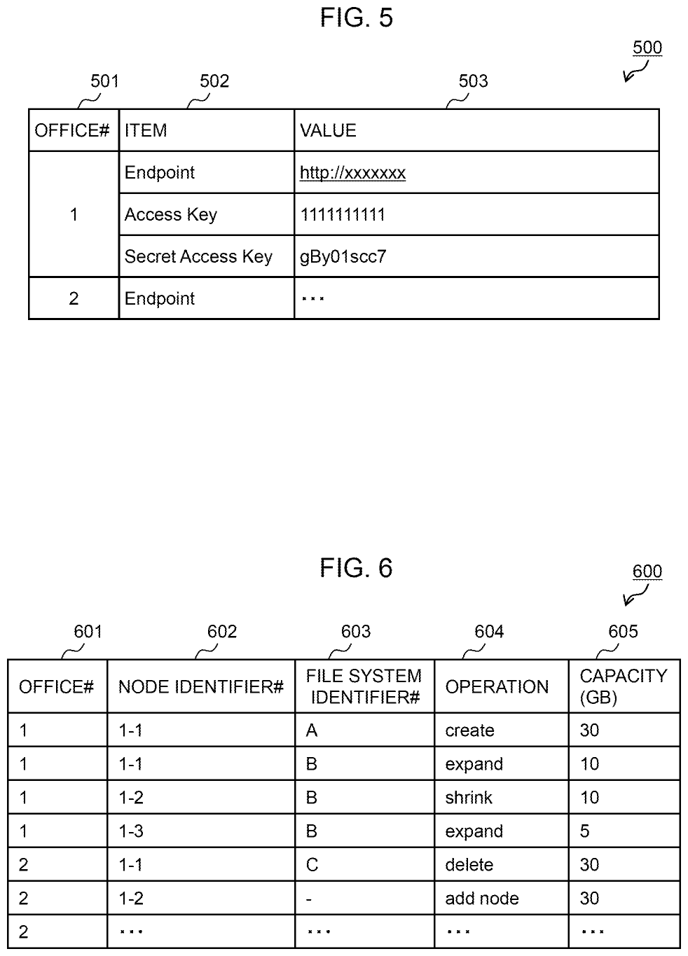

The link setting file 111 is a file including information for setting operations of the link unit 114. Note that the link setting file 111 will be described later with reference to FIG. 4. The link management file 112 is a file including information indicating a link target office and authentication information for linkage. The link management file 112 will be described later with reference to FIG. 5. The office management file 113 is a file including information indicating the amount of resources allocated to manage the real file 121 in the server device 101. The office management file 113 will be described later with reference to FIG. 6.

The link unit 114 periodically monitors the link setting file 111, and when a change or the like to the link setting file 111 is detected, acquires information necessary for various processing from the link setting file 111 and the link management file 112 according to the change content and performs the various processing (periodic link processing, materialization processing, and the like) using the acquired information. Periodic link processing is processing for acquiring the latest data of the link target server device 101. Materialization processing is processing for materializing data, and refers to processing of, when there is access to the stub file 122 of the link target server device 101, acquiring the real file 121 of the stub file 122 from the server device 101 and holding the real file 121.

The API accepting unit 115 accepts various requests from the user through the client terminal 102. For example, the API accepting unit 115 accepts “(appropriate) resource allocation amount” from the client terminal 102 and sets the resource allocation amount in the office management file 113.

The resource management unit 116 periodically monitors the office management file 113, and when a change or the like to the office management file 113 is detected, changes the amount of resources (expand or reduce file system, increase or decrease the number of nodes, and the like) according to the change content.

Note that while FIG. 1 shows the first office, the second office, and a third office as examples of the office, the number of offices is not limited to three. The number of offices may be two, or may be four or more, for example. Moreover, the number of server devices 101 in each office may be one, or may be more than one. Note that in the following, in order to simplify the description, an example is used in which one server device 101 is provided in each office.

FIG. 2 is a diagram showing an example of a configuration according to hardware of the data management system 100.

In the data management system 100, the server device 101 and the client terminal 102 are communicably coupled via a network 201 such as a local area network (LAN). One server device 101 is communicably coupled with another server device 101 via a network 202 such as a wide area network (WAN).

The server device 101 includes a controller 210 and a disk 220.

The controller 210 includes a central processing unit (CPU) 211, a memory 212, a cache 213, a first I/F 214, and a second I/F 215.

The CPU 211 controls operations of the server device 101. The CPU 211 is an example of a processor, and may be a micro processing unit (MPU), a graphics processing unit (GPU), an artificial intelligence (AI) chip, and so forth. The memory 212 is a random access memory (RAM), a read only memory (ROM), and so forth, and temporarily stores programs and data used for controlling operations of the CPU 211. The cache 213 temporarily stores write data written into the disk 220, read data read from the disk 220, and the like. The first I/F 214 performs communication with an external device such as the client terminal 102, the server device 101 in the other office, and the like. The second I/F 215 performs communication with the disk 220.

The disk 220 is a disk-type physical storage device (e.g., hard disk drive (HDD)). Other types of physical storage devices (e.g., flash memory device) may be adopted as the physical storage device. While a plurality of disks 220 are provided in FIG. 2, just one disk 220 may be provided. Alternatively, one or more RAID groups may be formed by a plurality of disks 220.

Note that the disk 220 may be provided outside the server device 101 and be provided in a storage device communicably coupled via a predetermined network (e.g., storage area network (SAN)), for example. In this case, the server device 101 receives a file-level I/O request from the client terminal 102 via the first I/F 214. The server device 101 creates an I/O request (block-level I/O request) for I/O of datablocks included in the file designated by the I/O request. The server device 101 transmits the block-level I/O request to the storage device via the second I/F 215.

Here, the functions (link unit 114, API accepting unit 115, resource management unit 116, and the like) of the server device 101 may be implemented by the CPU 211 reading a program onto the memory 212 and executing the program (software), may be implemented by hardware such as a dedicated circuit, or may be implemented by a combination of software and hardware. Note that a function of the server device 101 may be divided into a plurality of functions, or a plurality of functions may be combined as one function. Some functions of the server device 101 may be provided as another function or be included in another function. Alternatively, some functions of the server device 101 may be implemented by another computer that is communicable with the server device 101.

For example, instead of a configuration in which the server device 101 includes the link unit 114, the API accepting unit 115, and the resource management unit 116, a configuration in which the server device 101 includes a setting unit, a monitoring unit, an acquisition unit, a management unit, and a change unit may be adopted. In this case, the setting unit sets the link setting file 111 including information indicating acquisition of metadata in which real data is excluded from the real file 121 of the other office from the server device 101 in the other office. The monitoring unit monitors the link setting file 111 set by the setting unit. The acquisition unit acquires metadata of the real file 121 of the other office from the server device 101 in the other office according to the link setting file 111 whose change is detected by the monitoring unit. The management unit uses the metadata acquired by the acquisition unit to create and manage a stub file for referring to the real file 121 of the other office. The change unit changes allocation of the amount of resources necessary for managing the real file 121 of the own office.

The client terminal 102 includes a CPU 231, a memory 232, a cache 233, and an I/F 234. The client terminal 102 may include another type of storage resource in addition to or instead of the memory 232 and/or cache 233. The client terminal 102 transmits various requests (I/O request of file, expansion request described later, recall request described later, and the like) to the server device 101 via the I/F 234.

FIG. 3 is a diagram showing an example of a data structure of the stub file 122.

The stub file 122 is a file including information on a file mode 301, a permission 302, a last edition date and time 303, and a path name 304.

The file mode 301 is information indicating the type (directory, normal file, and so forth) of the real file 121. The permission 302 is information indicating the right to access (right to read, right to write, and the like) of the real file 121. The last edition date and time 303 is information indicating the time (date, time of day, and the like) when the real file 121 was last modified. The path name 304 is information indicating the location (e.g., full path) of the real file 121.

FIG. 4 is a diagram showing an example (link setting table 400) of the link setting file 111.

The link setting table 400 stores information in which a mode 401, a link office 402, an item 403, and a value 404 are associated with one another.

The mode 401 is a mode in which the link unit 114 operates. As the mode 401, “Stub” indicating that a data link is related to the stub file 122 and “recall” indicating that a link is related to the real file 121 are provided. The link office 402 is information used to identify the link target office. The item 403 is items indicating settings related to a link. As the item 403, “state” indicating whether or not to link data, “execution interval” indicating the interval of linking data, “CPU resource” indicating the number of cores of the CPU 211 necessary for the link, and “memory resource” indicating the capacity of the memory 212 necessary for the link are provided. The value 404 is information indicating the value of the item 403.

FIG. 5 is a diagram showing an example (link management table 500) of the link management file 112.

The link management table 500 stores information in which an office 501, an item 502, and a value 503 are associated with one another.

The office 501 is information for identifying the link target office. The item 502 is items indicating settings used for the link. As the item 502, “Endpoint,” “Access Key,” and “Secret Access Key” are provided. “Endpoint” is an item for identifying the link target office, and is a network address such as a uniform resource locator (URL) or a uniform resource identifier (URI). “Access Key” is a name (e.g., ID) of an authentication account when accessing the link target office. “Secret Access Key” is a password for an authentication account when accessing the link target office. The value 503 is information indicating the value of the item 502.

FIG. 6 is a diagram showing an example (office management table 600) of the office management file 113.

The office management table 600 stores records in which information on an office 601, a node identifier 602, a file system identifier 603, an operation 604, and a capacity 605 are associated with one another.

The office 601 is information for identifying an office. The node identifier 602 is information for identifying a node (disk 220, storage device, and the like). The file system identifier 603 is information for identifying a file system.

The operation 604 is information indicating an operation related to a file system. As the operation 604, “create,” “expand,” “shrink,” “delete,” “add node,” and the like are provided. The operation “create” indicates an operation of providing a file system. The operation “expand” indicates an operation of allocating an unused storage area of a node to a file system, or allocating a physical area of a node to which no logical area is allocated to a file system as a logical area. The operation “shrink” indicates an operation of reducing a storage area allocated to a file system. The operation “delete” indicates an operation of deleting a file system. The operation “add node” indicates an operation of allocating an unused node to a new file system.

Here, a file system is a system that manages and controls the recording state inside a node, and enables writing and reading of data in file units. One file system may be provided in each server device 101, or a plurality of (e.g., for each office, for each node, or for each partition) file systems may be provided in each server device 101.

The capacity 605 is information indicating the capacity of a storage area changed according to an operation related to a file system.

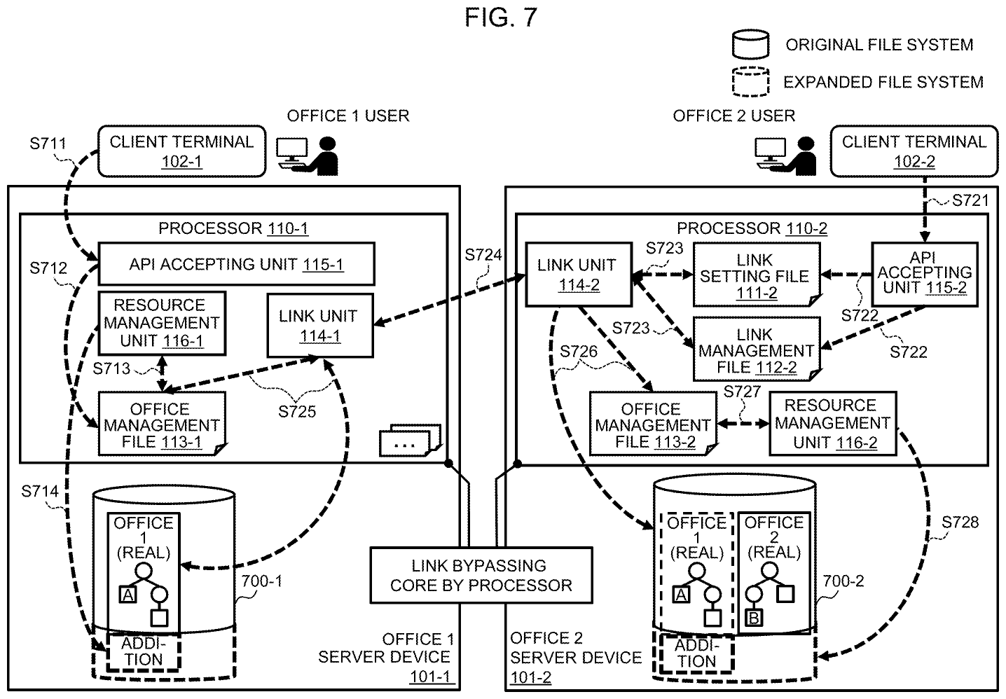

Next, data link processing will be described with reference to FIGS. 7 to 9. Note that in FIGS. 7 to 9, the server device 101-1 in the first office may be referred to as a link source server device 101, and the server device 101-2 in the second office may be referred to as a link destination server device 101.

FIG. 7 is a diagram showing an example of a processing flow of data link processing. In data link processing, the processors 110 in the offices link not only stub-forming information (information for creating stub file 122 of real file 121) of the real file 121, but also resource information (information of office management file 113) among the offices.

In S711, a processor 110-1 in the first office accepts an amount of resources (e.g., capacity by which to expand or reduce storage area managed by file system 700-1) necessary for managing the real file 121 of the first office input by the user via a client terminal 102-1. In S712, the processor 110-1 sets the accepted amount of resources in an office management file 113-1. In S713, the processor 110-1 periodically monitors the office management file 113-1. In S714, when there is a change in the office management file 113-1, the processor 110-1 changes (expands in present example) the capacity of a storage area managed by the file system 700-1 according to the change content.

In S721, a processor 110-2 in the second office accepts information (link information) related to a link with the server device 101 for which setting as a link target is desired input by the user via a client terminal 102-2. Link information includes operation information such as an execution interval of the link unit 114, authentication information necessary for linking with the link target server device 101, and so forth. Note that the user in the second office is assumed to have acquired the authentication information and the like in advance. Additionally, the user can freely set the link source server device 101. In S722, the processor 110-2 sets the accepted link information in a link setting file 111-2 and a link management file 112-2.

In S723 to S725, the processor 110-2 acquires link data from the link source server device 101-1 on the basis of the link setting file 111-2 and the link management file 112-2. For example, the processor 110-2 acquires, as link data, information (example of resource information) on the first office of the office management file 113-1 together with stub-forming information (information for creating stub file 122-21) of a real file 121-1 at the link source. In S726, the processor 110-2 stores the stub file 122-21 by a file system 700-2, and sets (e.g., adds) the information on the first office of the office management file 113-1 in an office management file 113-2.

In S727, the processor 110-2 periodically monitors the office management file 113-2. In S728, when there is a change in the office management file 113-2, if information on the first office of the office management file 113-1 is added, the processor 110-2 changes the capacity of the storage area for the first office managed by the file system 700-2.

According to the above configuration, since resource information is periodically shared, it is possible to avoid a situation where processing consumes time due to capacity shortage at the time of recall processing.

Additionally, according to the above configuration, since the cloud system is bypassed, unnecessary costs are not incurred. Moreover, since the link source server device 101 can be set, the user can limit the link target. Also, in order to link the amount of resources necessary for managing the real file 121, the user performs an operation to add the allocation of resource amount to the setting information. Hence, it is possible to reduce the trouble of executing commands one by one in the resource operation and the like.

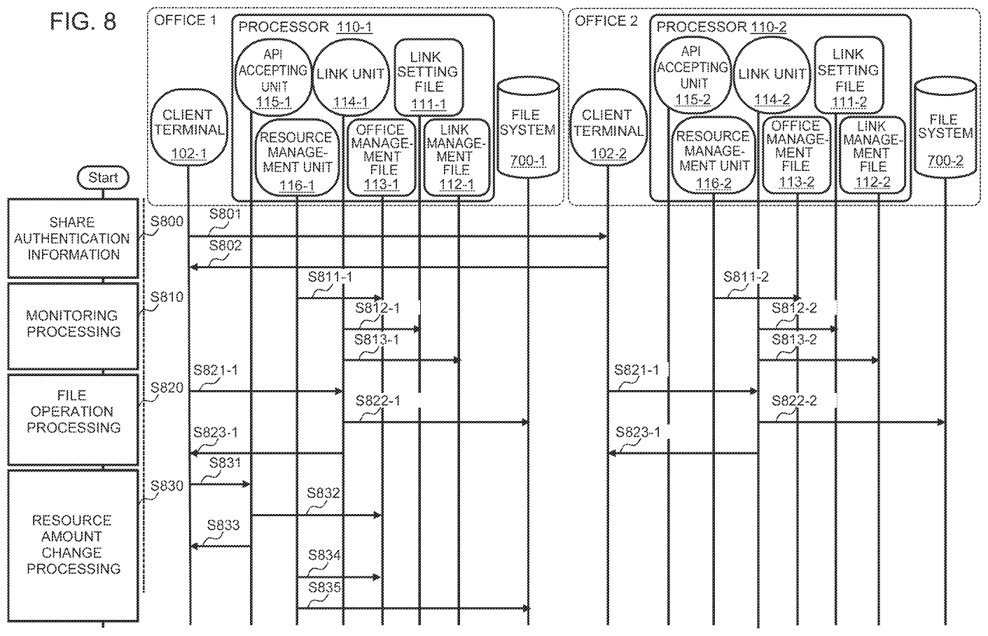

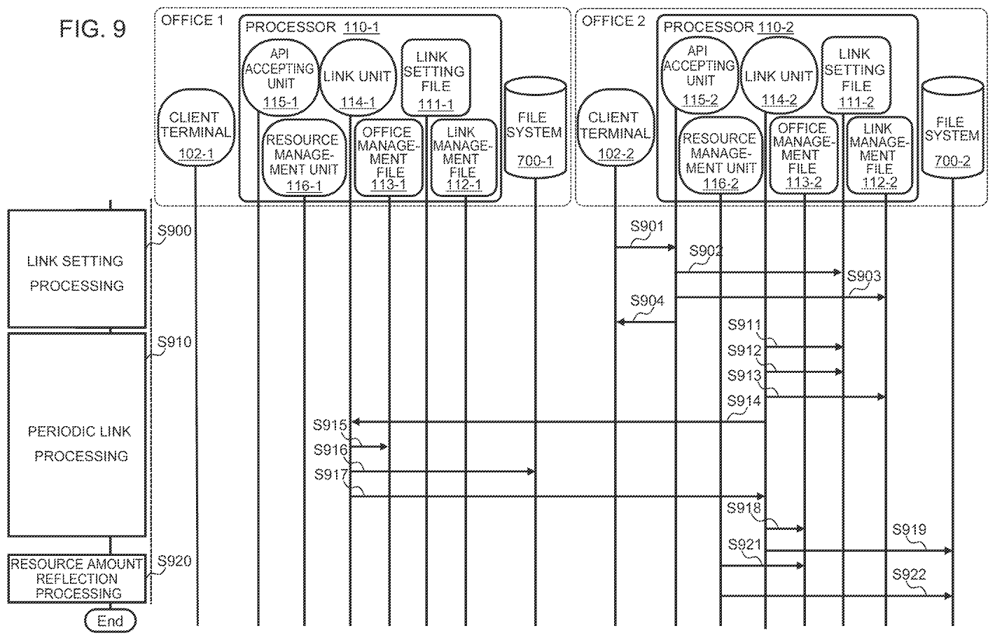

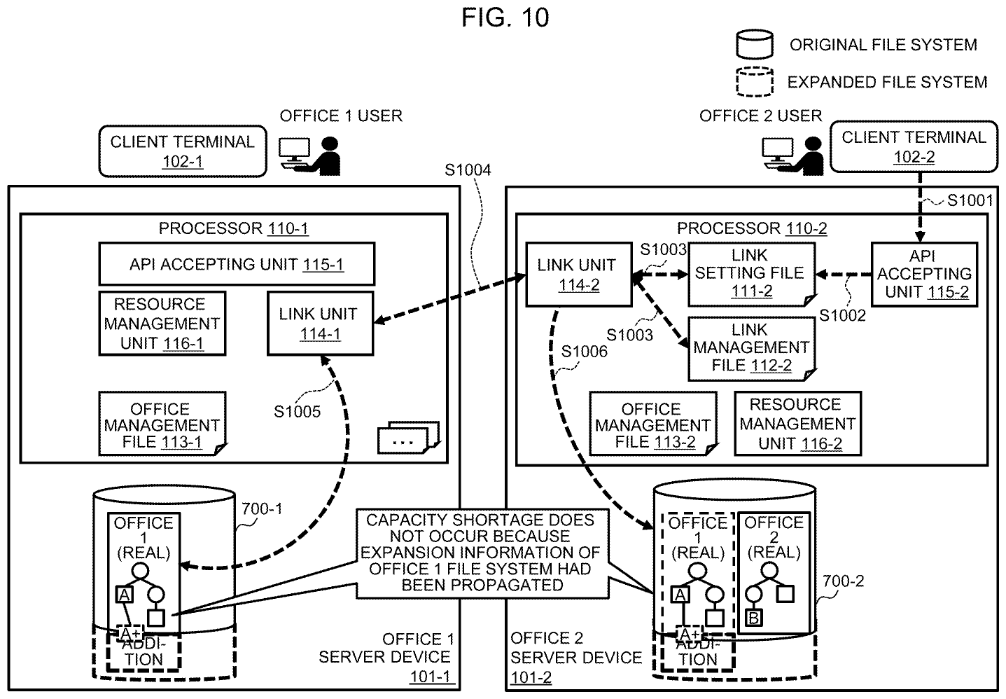

FIGS. 8 and 9 are diagrams showing an example of a sequence according to data link processing. Data link processing will be described in detail with reference to FIGS. 8 and 9.

In S800, the client terminal 102-1 in the first office and the client terminal 102-2 in the second office share authentication information used for linkage. For example, in S801, in response to an authentication information request from the user in the first office or the user (client terminal 102-2 in second office) in the second office, the client terminal 102-1 in the first office transmits authentication information (ID, password, and so forth) to the client terminal 102-2 in the second office. In S802, the client terminal 102-2 in the second office transmits information indicating receipt of the authentication information to the client terminal 102-1 in the first office.

In S810, monitoring processing is performed. The server device 101 of each office monitors predetermined information at a predetermined timing as a presupposed operation. For example, in S811, the resource management unit 116 periodically monitors the office management file 113. In S812, the link unit 114 periodically monitors the link setting file 111. In S813, the link unit 114 periodically monitors the link management file 112.

In S820, processing (file operation processing) related to file operations on the real file 121 of the own office is performed in each office. For example, in S821, the client terminal 102 transmits writing to a predetermined real file 121 or reading of a predetermined real file 121 (I/O request) to the server device 101. In S822, the link unit 114 notifies the file system 700 of the I/O request for the real file 121, and receives a response to the I/O request from the file system 700. In S823, the link unit 114 transmits the received response to the client terminal 102.

In S830, resource amount change processing is performed. For example, in S831, the client terminal 102-1 in the first office transmits expansion of the capacity of a storage area managed by the file system 700-1 (expansion request) to the server device 101-1. In S832, the API accepting unit 115 accepts the expansion request, and changes the office management file 113-1 according to the expansion request. In S833, the API accepting unit 115 transmits whether or not the change has been made to the client terminal 102-1. In S834, a resource management unit 116-1 detects the change in the office management file 113-1. In S835, the resource management unit 116-1 expands the capacity of the storage area managed by the file system 700-1 according to the detected change content.

In S900, link setting processing is performed. For example, in S901, the client terminal 102-2 transmits information (link information) indicating that the server device 101-1 in the first office is set as the link source server device 101 to the server device 101-2. In S902, an API accepting unit 115-2 sets (e.g., adds) operation information included in the link information in the link setting file 111-2. In S903, the API accepting unit 115-2 sets (e.g., adds) authentication information included in the link information in the link management file 112-2. In S904, the API accepting unit 115-2 transmits information indicating whether or not the setting has been made to the client terminal 102-2.

In S910, periodic link processing is performed. For example, in S911, a link unit 114-2 detects a change in the link setting file 111-2 in the monitoring processing. In S912, the link unit 114-2 acquires a change content such as the cycle time to link with the link source server device 101-1 from the link setting file 111-2. In S913, the link unit 114-2 acquires authentication information necessary for linking with the link source server device 101-1 from the link management file 112-2. In S914, the link destination link unit 114-2 acquires link data from the link source server device 101-1. For example, the link unit 114-2 instructs (link instruction) a link source link unit 114-1 to transmit link data. A link instruction includes, for example, information for identifying the link source server device 101, information for identifying the link destination server device 101, and information instructing transmission of link data to the link destination server device 101. Note that authentication information may be included in the link instruction, or may be transmitted to the link source server device 101 separately from the link instruction.

In S915, the link source link unit 114-1 performs authentication using the authentication information, and if the authentication is successful, acquires information on the first office from the office management file 113-1. At this time, the link unit 114-1 may acquire the entire information on the first office, or may acquire information on the difference from the last data linkage. Note that although not shown, if the authentication is unsuccessful, the link source link unit 114-1 transmits failure of the authentication to the link destination link unit 114-2.

In S916, the link unit 114-1 acquires the real file 121 from the file system 700-1, deletes actual data (real data) from the acquired real file 121, and creates stub-forming information including only metadata (file mode, permission, last edition date and time, path name, and the like). At this time, the link unit 114-1 may acquire the entire stub-forming information of the real file 121-1, or may acquire stub-forming information of the real file 121-1 that has been changed from the last data linkage in the real file 121. In S917, the link unit 114-1 transmits information on the first office in the office management file 113-1 acquired in S915 and stub-forming information acquired in S916 to the link unit 114-2.

In S918, the link unit 114-2 sets (e.g., adds) the received information on the first office in the office management file 113-1 in the office management file 113-2. In S919, the link unit 114-2 creates the stub file 122-21 on the basis of the received stub-forming information, and stores the created stub file 122-21 by the file system 700-2.

In S920, resource amount reflection processing is performed. For example, in S921, a resource management unit 116-2 detects a change in the office management file 113-2 in the monitoring processing. In S922, the resource management unit 116-2 changes the capacity of the storage area for the first office managed by the file system 700-2 according to the change content (added information on first office in office management file 113-1).

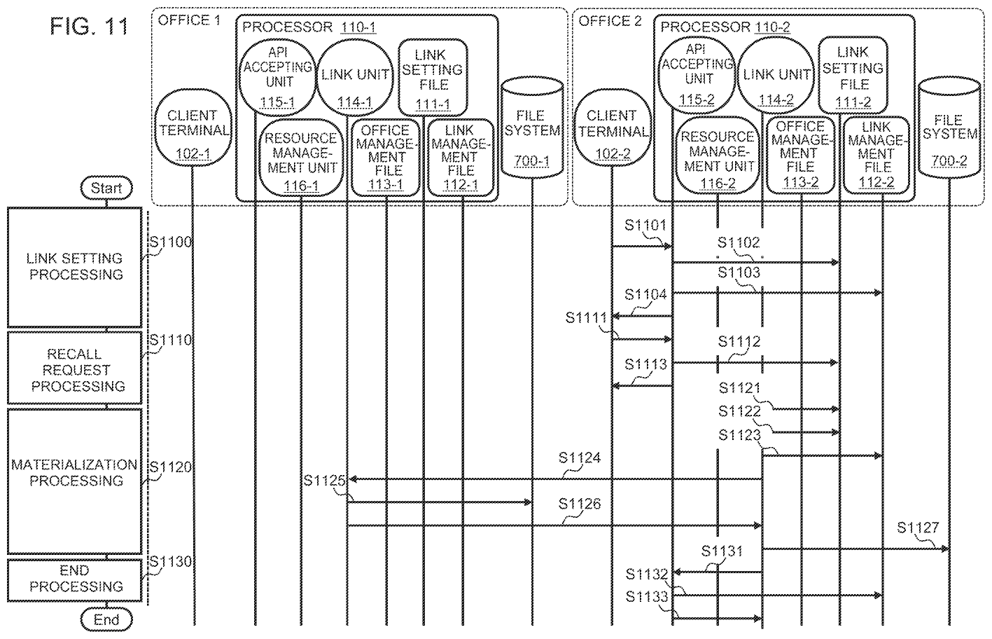

Next, recall processing will be described with reference to FIGS. 10 and 11. Note that in FIGS. 10 and 11, the server device 101-1 in the first office may be referred to as a link source server device 101, and the server device 101-2 in the second office may be referred to as a link destination server device 101.

FIG. 10 is a diagram showing an example of a processing flow of recall processing. In recall processing, the user in the second office uses data of the first office to analyze data, for example. Hence, recall processing is started when a request (recall request) is made to refer to data of the first office.

In 51001, the client terminal 102-2 accepts a recall request from the user in the second office, and transmits the recall request to the API accepting unit 115-2.

In 51002, the API accepting unit 115-2 set information on the recall request in the link setting file 111-2.

In 51003, the link unit 114-2 monitors the link setting file 111-2 and performs processing according to the change content. Since the change content is a recall request in this example, the link unit 114-2 acquires information necessary for a recall instruction from the link setting file 111-2 and the link management file 112-2. Note that a recall instruction includes information for identifying the link source server device 101, information for identifying the link destination server device 101, and information instructing transmission of the link source real file 121 to the link destination server device 101.

In S1004, the link unit 114-2 transmits the recall instruction to the link unit 114-1 in the first office.

In S1005, the link unit 114-1 acquires the real file 121-1 of the first office and transmits the real file 121-1 to the link unit 114-2 in the second office.

In S1006, the link unit 114-2 converts (e.g., replaces) the stub file 122-21 of the first office into the real file 121-1.

Note that since the expansion (addition) of the resource amount of the first office is also reflected to the second office at the time of data link processing, the real file 121 can be acquired without any shortage of resource amount in the recall processing.

FIG. 11 is a diagram showing an example of a sequence according to recall processing. Recall processing will be described in detail with reference to FIG. 11.

In S1100, link setting processing is performed. Note that since the processing of S1101 to 51104 is the same as the processing of S901 to S904, descriptions will be omitted.

In S1110, recall request processing is performed. For example, in 51111, the client terminal 102-2 transmits a recall request to the API accepting unit 115-2. In 51112, the API accepting unit 115-2 sets information indicating transmission of the recall instruction in the link setting file 111-2 on the basis of the received recall request. For example, if there is a record in which the mode 401 is “recall” and the link office 402 is “1” in the link setting table 400, the API accepting unit 115-2 changes the value 404 of the item 403 “state” to “ON.” Note that if there is no such record, the API accepting unit 115-2 adds a record in which the value 404 of the item 403 “state” is set to “ON.” In 51113, the API accepting unit 115-2 responds to the client terminal 102-2 as to whether or not the setting has been made in the link setting file 111-2.

In S1120, materialization processing is performed. For example, in S1121, the link unit 114-2 detects a change in the link setting file 111-2 in the monitoring processing. In S1122, the link unit 114-2 acquires the change content from the link setting file 111-2. In this example, the link unit 114-2 acquires information “1” indicating the first office as information for identifying the link source office associated with the change content “ON.” In S1123, the link unit 114-2 acquires, from the link management file 112-2, authentication information and the like necessary for linking with the server device 101-1 in the link source office on the basis of the information for identifying the link source office.

In S1124, in order to acquire the real file 121 (user data) of the first office, the link unit 114-2 transmits a recall instruction to the link unit 114-1 in the first office. Note that authentication information may be included in the recall instruction, or may be transmitted to the server device 101-1 in the first office separately from the recall instruction.

In S1125, the link unit 114-1 performs authentication using the authentication information, and if the authentication is successful, acquires the real file 121-1 of the first office from the file system 700-1. In S1126, the link unit 114-1 transmits the real file 121-1 of the first office to the link unit 114-2 in the second office. In S1127, the link unit 114-2 instructs the file system 700-2 to convert (materialize) the stub file 122-21 of the first office into the real file 121-1.

In S1130, end processing is performed. For example, in S1131, the link unit 114-2 notifies the API accepting unit 115-2 that the materialization processing has been completed. In S1132, the API accepting unit 115-2 sets information (e.g., “OFF”) indicating completion of the materialization processing in the link setting file 111-2. In S1133, the API accepting unit 115-2 notifies the link unit 114-2 as to whether or not the setting has been made in the link management file 112-2.

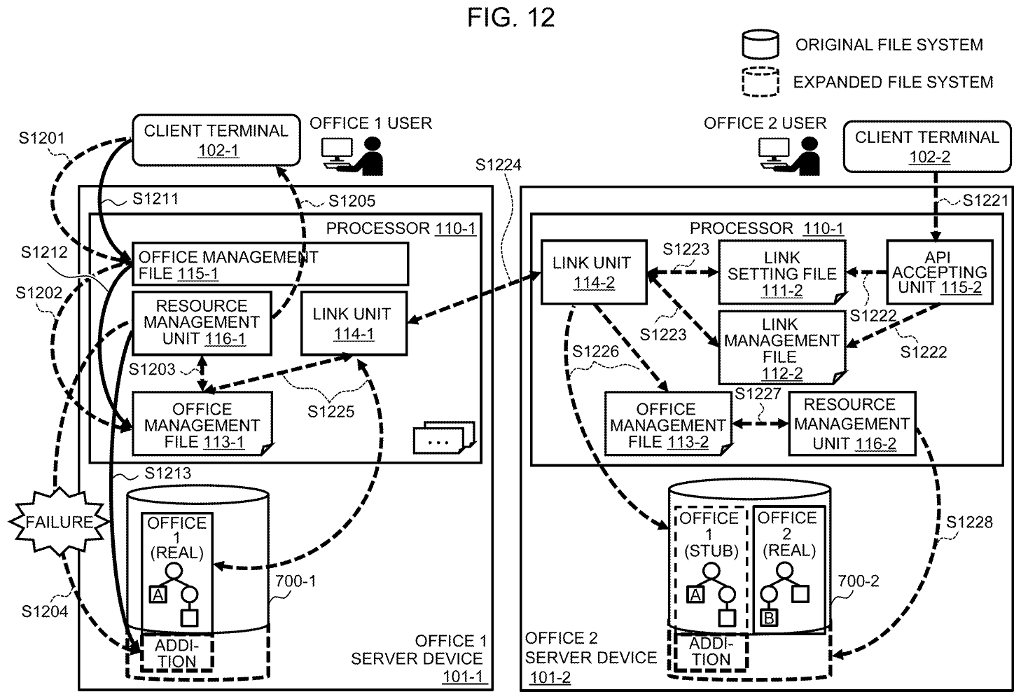

Next, error processing will be described with reference to FIGS. 12 to 14. Note that in FIGS. 12 to 14, the server device 101-1 in the first office may be referred to as a link source server device 101, and the server device 101-2 in the second office may be referred to as a link destination server device 101.

FIG. 12 is a diagram showing an example of a processing flow of error processing. In error processing, when an error occurs at the time of changing a resource amount, the user is notified of the error. The user deals with the error, and then resets the amount of resources necessary for management of the real file 121. Note that in the following description, expansion of the resource amount is used as an example of a change in the resource amount.

In S1201, the client terminal 102-1 transmits a request (expansion request) for expanding the capacity of the storage area managed by the file system 700-1 to an API accepting unit 115-1. In S1202, the API accepting unit 115-1 changes the office management file 113-1 according to the expansion request. In S1203, the resource management unit 116-1 monitors the office management file 113-1, and in this example, is assumed to detect a change in the office management file 113-1. In S1204, the resource management unit 116-1 expands the capacity of the storage area managed by the file system 700-1 according to the change content, and in this example, it is assumed that there is a failure and an error occurs. In S1205, the resource management unit 116-1 transmits occurrence of the error to the client terminal 102-1. When confirming the error, the user deals with the error, and then restores or modifies the capacity of the storage area managed by the file system 700-1.

In S1211, the client terminal 102-1 transmits a request (modification request) to modify the capacity of the storage area managed by the file system 700-1 to the API accepting unit 115-1. In S1212, the API accepting unit 115-1 changes the office management file 113-1 according to the modification request. In S1213, the resource management unit 116-1 detects the change in the office management file 113-1, and changes the capacity of the storage area for the first office managed by the file system 700-1 according to the change content.

In S1221, the client terminal 102-2 transmits, to the API accepting unit 115-2, information (link information) related to a link with the server device 101 for which setting as a link target is desired, which is information input by the user. In S1222, the API accepting unit 115-2 sets the received link information in the link setting file 111-2 and the link management file 112-2.

In S1223, the link unit 114-2 monitors the link setting file 111-2, and when detecting a change in or determining that an execution interval has passed for the link source office (first office in this example), acquires information on the first office in the link management file 112-2. In S1224, the link unit 114-2 instructs (link instruction) the link unit 114-1 in the first office to transmit link data (information on first office in office management file 113-1 and stub-forming information of real file 121-1 of first office). In S1225, the link unit 114-1 acquires the instructed information on the first office in the office management file 113-1 and the stub-forming information of the real file 121-1 of the first office, and transmits the acquired information to the link unit 114-2 in the second office (link destination).

In S1226, the link unit 114-2 sets the received information on the first office in the office management file 113-1 in the office management file 113-2, creates the stub file 122-21 of the real file 121-1 on the basis of the stub-forming information of the real file 121-1 of the first office, and stores the stub file 122-21 by the file system 700-2. In S1227, the resource management unit 116-2 monitors the office management file 113-2, and when a change is detected, acquires the change content from the office management file 113-2. In S1228, the resource management unit 116-2 changes the capacity of the storage area for the first office managed by the file system 700-2 according to the change content.

According to the above configuration, even when an error occurs in the link source and information on the link source in the office management file 113-2 is actually different from the capacity of the storage area managed by the file system 700-1 at the link source, the user in the link source office reads the office management file 113 in which the error is dealt with at the time of the next data linkage (latest link data is periodically acquired at link destination), so that data can be synchronized between the offices.

As described above, even if the second office linked with the first office acquires information of the office management file 113 in which the change is not made due to an error, since the second office reads the latest information of the office management file 113 at the time of the next data linkage and makes the change according to the information of the office management file 113, data synchronization is ensured.

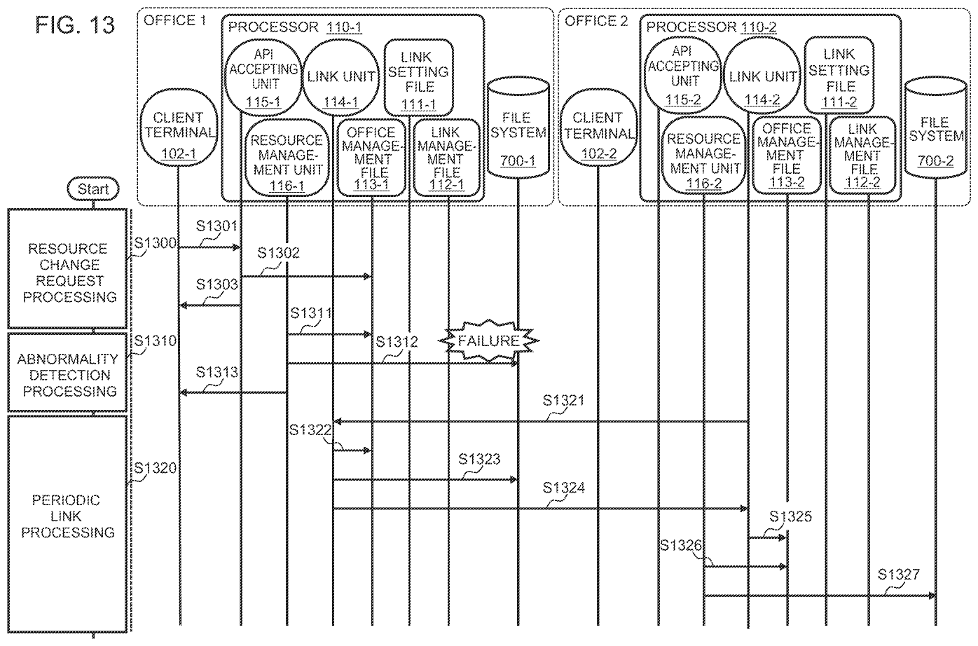

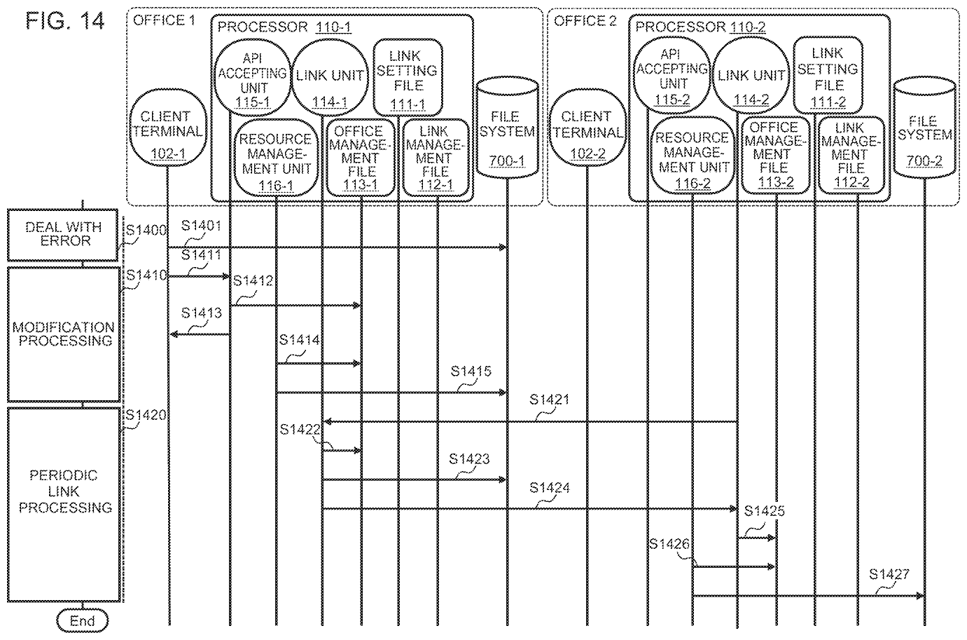

FIGS. 13 and 14 are diagram showing an example of a sequence according to error processing. Error processing will be described in detail with reference to FIGS. 13 and 14.

In S1300, processing (resource change request processing) related to an operation of changing the amount of resources necessary for management of the real file 121 is performed. For example, in S1301, the client terminal 102-1 transmits a request (expansion request) for expanding the capacity of the storage area managed by the file system 700-1 to the API accepting unit 115-1. In S1302, the API accepting unit 115-1 sets the office management file 113-1 according to the expansion request. In S1303, the API accepting unit 115-1 transmits whether or not the setting has been made in the office management file 113-1 to the client terminal 102-1.

In S1310, abnormality detection processing is performed. For example, in S1311, the resource management unit 116-1 monitors the office management file 113-1, and when there is a change in the office management file 113-1, acquires the change content. In S1312, the resource management unit 116-1 expands the capacity of the storage area managed by the file system 700-1 according to the change content. The following description will be given on the assumption that an error (failure) has occurred in S1312. In S1313, the resource management unit 116-1 transmits occurrence of the error to the client terminal 102-1.

In S1320, periodic link processing is performed. For example, in S1321, the link unit 114-2 acquires link data from the link source server device 101-1. For example, the link unit 114-2 instructs (link instruction) the link source link unit 114-1 to transmit link data. In S1322, the link source link unit 114-1 performs authentication using the authentication information, and if the authentication is successful, acquires information on the first office from the office management file 113-1. In S1323, the link unit 114-1 acquires information (stub-forming information) for creating the real file 121-1 managed in the file system 700-1 as the stub file 122-21. In S1324, the link unit 114-1 transmits the information on the first office in the office management file 113-1 acquired in S1322 and the stub-forming information acquired in S1323 to the link unit 114-2.

In S1325, the link unit 114-2 sets the received information on the first office in the office management file 113-1 in the office management file 113-2. In S1326, the resource management unit 116-2 detects a change in the office management file 113-2. In S1327, the resource management unit 116-2 expands the capacity of the storage area for the first office managed by the file system 700-2 according to the change content. Note that since an error has occurred in the first office, the capacity of the storage area for the first office managed by the file system 700-2 is different from the capacity in the first office.

In S1400, the error is dealt with. For example, in S1401, the user performs an operation to eliminate the cause of the error via the client terminal 102-1.

In S1410, modification processing is performed. For example, in S1411, the client terminal 102-1 in the first office transmits modification (modification request) of the capacity of the storage area managed by the file system 700-1 to the server device 101-1. In S1412, the API accepting unit 115 sets the office management file 113-1 according to the modification request. In S1413, the API accepting unit 115 transmits whether or not the setting has been made in the office management file 113-1 to the client terminal 102-1. In S1414, the resource management unit 116-1 detects a change in the office management file 113-1. In S1415, the resource management unit 116-1 changes the capacity of the storage area for the first office managed by the file system 700-1 according to the change content.

In S1420, periodic link processing is performed. For example, in S1421, the link unit 114-2 acquires link data from the link source server device 101-1. For example, the link unit 114-2 instructs (link instruction) the link source link unit 114-1 to transmit the link data. In S1422, the link source link unit 114-1 performs authentication using the authentication information, and if the authentication is successful, acquires information on the first office from the office management file 113-1. In S1423, the link unit 114-1 acquires information (stub-forming information) for creating the real file 121-1 managed in the file system 700-1 as the stub file 122-21. In S1424, the link unit 114-1 transmits the information on the first office in the office management file 113-1 acquired in S1422 and the stub-forming information acquired in S1423 to the link unit 114-2.

In S1425, the link unit 114-2 sets the received information on the first office in the office management file 113-1 in the office management file 113-2. In S1426, the resource management unit 116-2 detects a change in the office management file 113-2. In S1427, the resource management unit 116-2 changes the capacity of the storage area for the first office managed by the file system 700-2 according to the change content.

According to the above configuration, since the first office recovers from failure and performs periodic link processing, the capacity of the storage area for the first office managed by the file system 700-2 in the second office becomes the same as the capacity in the first office, whereby data synchronization is ensured.

### (II) Supplement

The above embodiment includes the following contents, for example.

While the above embodiment describes a case where the present invention is applied to a data management system, the present invention is not limited to this, and is widely applicable to other various systems, devices, methods, and programs.

In the above embodiment, a part or all of the program may be installed into an device such as a computer that implements a server device from a program source. The program source may be a program distribution server coupled by a network or a computer readable recording medium (e.g., non-transitory recording medium). In the above description, two or more programs may be implemented as one program, or one program may be implemented as two or more programs.

In the above embodiment, the configuration of each table is an example, and one table may be divided into two or more tables, or all or some of the two or more tables may be one table.

In the above embodiment, while information related to the data management system is described using tables for convenience of description, the data structure is not limited to a table. Information related to the data management system may be expressed in a data structure other than a table, such as extensible markup language (XML), YAML Ain′t a Markup Language (YAML), a hash table, or a tree structure.

In the above description, information such as a program, a table, and a file that implements each function may be placed in a storage device such as a memory, a hard disk, or a solid state drive (SSD), or a recording medium such as an IC card, an SD card, or a DVD.

The above embodiment has the following characteristic configuration.

(1)

A data management system (e.g., data management system 100) including one or more server devices (e.g., server device 101) provided in each of a plurality of offices, in which: the server device includes a setting unit (e.g., processor 110, API accepting unit 115, circuit) that sets setting information (e.g., link setting file 111, link management file 112) including information (e.g., value 404 “ON/OFF” of item 403 “state”) indicating acquisition of metadata in which real data is excluded from data (e.g., real file 121) of another office from a server device in the other office, a monitoring unit (e.g., processor 110, link unit 114, circuit) that monitors setting information set by the setting unit, an acquisition unit (e.g., processor 110, link unit 114, circuit) that acquires metadata of data of the other office from the server device in the other office according to setting information in which a change is detected by the monitoring unit, and a management unit (e.g., processor 110, link unit 114, circuit) that creates stub data which is data not including real data of data of the other data office and is data for referring to the data of the other office from metadata acquired by the acquisition unit and manages the stub data; when receiving a request for data of the other office from a client terminal (e.g., client terminal 102), the setting unit sets information indicating acquisition of data of the other office in setting information; and the acquisition unit acquires the data of the other office from the server device in the other office according to the setting information in which a change is detected by the monitoring unit.

In the above configuration, a server device in one office directly acquires data of another office used for data analysis, for example, by bypassing the cloud system (core). According to the above configuration, when data of the other office is requested by the one office, for example, the server device in the one office acquires the data directly. Hence, the user in the other office is not required to upload the data to the cloud system, and a situation of accidentally transferring classified information to the cloud system can be avoided.

(2)

The server device includes a change unit (e.g., processor 110, resource management unit 116, circuit) that changes allocation of an amount of resources (e.g., number of nodes or capacity of storage area) necessary for managing data of the own office; the setting unit sets setting information including information indicating acquisition of metadata of data of the other office and resource information (e.g., information of office management file 113) indicating the amount of resources necessary for managing data of the other office from the server device in the other office; the acquisition unit acquires the metadata and the resource information from the server device in the other office according to setting information in which a change is detected by the monitoring unit; and the change unit changes allocation of the amount of resources necessary for managing data of the other office according to the resource information acquired by the acquisition unit.

According to the above configuration, when a server device in one office acquires data from a server device in another office, for example, it is possible to avoid a situation where data cannot be acquired due to shortage of the capacity of the storage area.

(3)

The setting unit sets setting information including information (e.g., value 404 of item 403 “execution interval”) indicating acquisition of metadata of data of the other office and resource information indicating an amount of resources necessary for managing data of the other office from the server device in the other office every fixed time, and when the fixed time passes, the acquisition unit acquires the metadata and the resource information from the server device in the other office.

According to the above configuration, since resource information of the other office is acquired every fixed time, for example, when the resource amount of the other office is changed, the change can be reflected to the own office and the resource amount of the own office and the resource amount of the other office can be kept the same.

(4)

The setting unit sets setting information including information indicating acquisition of the metadata and the resource information from the server device in the other office in response to an input from a client terminal.

According to the above configuration, since the user can set a link target in advance, for example, it is possible to avoid a situation where data of an unintended office is acquired at the time of data analysis.

(5)

When acquiring the metadata from the server device in the other office, the acquisition unit transmits authentication information (e.g., value 503 of item 502 “Access Key”, value 503 of item 502 “Secret Access Key”) used for authentication in the server device in the other office to the server device in the other office.

According to the above configuration, since authentication is performed when acquiring metadata, for example, it is possible to avoid transmission of metadata to an unintended office.

(6)

When acquiring data of the other office from the server device in the other office, the acquisition unit transmits authentication information (e.g., value 503 of item 502 “Access Key”, value 503 of item 502 “Secret Access Key”) used for authentication in the server device in the other office to the server device in the other office.

According to the above configuration, since authentication is performed when acquiring data of the other office, for example, it is possible to avoid transmission of data to an unintended office.

The above configuration may be appropriately modified, replaced, combined, or omitted without departing from the gist of the present invention.

It should be understood that an item included in a list in the form of “at least one of A, B, and C” refers to (A), (B), (C), (A and B), (A and C), (B and C), or (A, B, and C). Similarly, an item listed in the form of “at least one of A, B, or C” can refer to (A), (B), (C), (A and B), (A and C), (B and C), or (A, B, and C).

What is claimed is:

1. A data management system comprising one or more server devices provided in each of a plurality of offices, wherein:
the server device includes
a setting unit that sets setting information including information indicating acquisition of metadata in which real data is excluded from data of another office from a server device in the another office,
a monitoring unit that monitors setting information set by the setting unit,
an acquisition unit that acquires metadata of the data of the another office from the server device in the another office according to setting information in which a change is detected by the monitoring unit, and
a management unit that creates stub data which is data not including real data of the data of the another office and is data for referring to the data of the another office from metadata acquired by the acquisition unit and manages the stub data;
when receiving a request for the data of the another office from a client terminal, the setting unit sets information indicating acquisition of the data of the another office in setting information; and
the acquisition unit acquires the data of the another office from the server device in the another office according to the setting information in which a change is detected by the monitoring unit.

2. The data management system according to claim 1, wherein:
the server device includes a change unit that changes allocation of an amount of resources necessary for managing data of an own office;
the setting unit sets setting information including information indicating acquisition of metadata of data of the another office and resource information indicating the amount of resources necessary for managing the data of the another office from the server device in the another office;
the acquisition unit acquires the metadata and the resource information from the server device in the another office according to setting information in which a change is detected by the monitoring unit; and
the change unit changes allocation of the amount of resources necessary for managing the data of the another office according to the resource information acquired by the acquisition unit.

3. The data management system according to claim 2, wherein
the setting unit sets setting information including information indicating acquisition of metadata of data of the another office and resource information indicating an amount of resources necessary for managing the data of the another office from the server device in the another office every fixed time, and
when the fixed time passes, the acquisition unit acquires the metadata and the resource information from the server device in the another office.

4. The data management system according to claim 2, wherein
the setting unit sets setting information including information indicating acquisition of the metadata and the resource information from the server device in the another office in response to an input from a client terminal.

5. The data management system according to claim 1, wherein
when acquiring the metadata from the server device in the another office, the acquisition unit transmits authentication information used for authentication in the server device in the another office to the server device in the another office.

6. The data management system according to claim 1, wherein
when acquiring the data of the another office from the server device in the another office, the acquisition unit transmits authentication information used for authentication in the server device in the another office to the server device in the another office.

7. A data management method in a data management system including one or more server devices provided in each of a plurality of offices, wherein:
the server device includes
a setting unit that sets setting information including information indicating acquisition of metadata in which real data is excluded from data of another office from a server device in the another office,
a monitoring unit that monitors setting information set by the setting unit,
an acquisition unit that acquires metadata of the data of the another office from the server device in the another office according to setting information in which a change is detected by the monitoring unit, and
a management unit that creates stub data which is data not including real data of the data of the another office and is data for referring to the data of the another office from metadata acquired by the acquisition unit and manages the stub data;
when receiving a request for the data of the another office from a client terminal, the setting unit sets information indicating acquisition of the data of the another office in setting information; and
the acquisition unit acquires the data of the another office from the server device in the another office according to the setting information in which a change is detected by the monitoring unit.

8. A non-transitory computer readable medium storing a program that, in a data management system including one or more server devices provided in each of a plurality of offices, causes a computer in the server device to function as
a setting unit that sets setting information including information indicating acquisition of metadata in which real data is excluded from data of another office from a server device in the another office,
a monitoring unit that monitors setting information set by the setting unit,
an acquisition unit that acquires metadata of the data of the another office from the server device in the another office according to setting information in which a change is detected by the monitoring unit, and
a management unit that creates stub data which is data not including real data of the data of the another office and is data for referring to the data of the another office from metadata acquired by the acquisition unit and manages the stub data,
when receiving a request for the data of the another office from a client terminal, the setting unit setting information indicating acquisition of the data of the another office in setting information, and
the acquisition unit acquiring the data of the another office from the server device in the another office according to the setting information in which a change is detected by the monitoring unit.
